(19) United States
(12) Patent Application Publication
(10) Pub. No.: US 2008/0023510 A1
(43) Pub. Date: Jan. 31, 2008

(54) Sectional, non-intrusive bicycle rack

(76) Inventor: James C. Falk, Carrollton, TX (US)

Correspondence Address: JAMES C FALK, 3310 HILLPARK LN, CARROLLTON, TX, 75007, US

(21) Appl. No.: 11/494,004

(22) Filed: Jul. 28, 2006

(51) Int. Cl. B60R 9/00; B60R 7/00

(52) U.S. Cl. 224/403; 224/924

(57) ABSTRACT

Sectional bicycle rack for carrying a bicycle in the bed of a vehicle, having adjustable length horizontal cross member bars at the top and base which when extended form a pressure clamp to the side walls of the vehicle bed for an easy and non-intrusive installation. The number of bicycles to be carried is adjusted by adding additional rack sections. Additionally, support brackets can be used to bolt the top cross member to the vehicle bed for permanent installation, added support or security.

### BACKGROUND OF THE INVENTION

There currently exist many devices for carrying a bicycle in or on a car/truck. However they require permanently bolting the device or some mechanism onto the frame of the vehicle. This invention does not require an intrusive mounting, instead an extendable bar utilizing pressure and friction between the two side walls of the vehicle to hold the rack in place supports the bicycles. Additionally, many of the current bicycle transport systems require the removal of the front tire from the bicycle. This racking system allows either the front or rear tire to be secured in place and does not require the removal of the front wheel.

Current bicycle carrying mechanisms support a pre-determined or fixed number of bicycles for carrying. This invention uses a series of interconnecting racks so the number of bicycles it carries can be altered to fit the needs and/or size of the vehicle. Additionally, a specialized clamp for permanently mounting the bicycle rack to vehicle (either on the back wall or its top rail) which also adds tie down points (points in the truck bed to secure cargo for carrying—especially the bicycles) is also claimed.

### BRIEF DESCRIPTION OF THE DRAWINGS

Figures: Attached to this claim are drawings labeled FIG. 1-4 showing:

FIG. 1—Top View: depicting installation in a “Pick Up truck bed” as viewed from above. It identifies and labels all parts.

FIG. 2—Side View: depicting installation in a “Pick Up truck bed” as viewed from the side. Shows the angle of installation in the truck bed.

FIG. 3—Rack detail: depicts rack spacing and measurement details, and again identifies and labels parts.

FIG. 4—Clamp Detail: Shows Two (2) views. First on the left a TOP view as depicted on earlier drawing (FIGS. 1 & 3) and on the right a SIDE View showing clamp details and measurements.

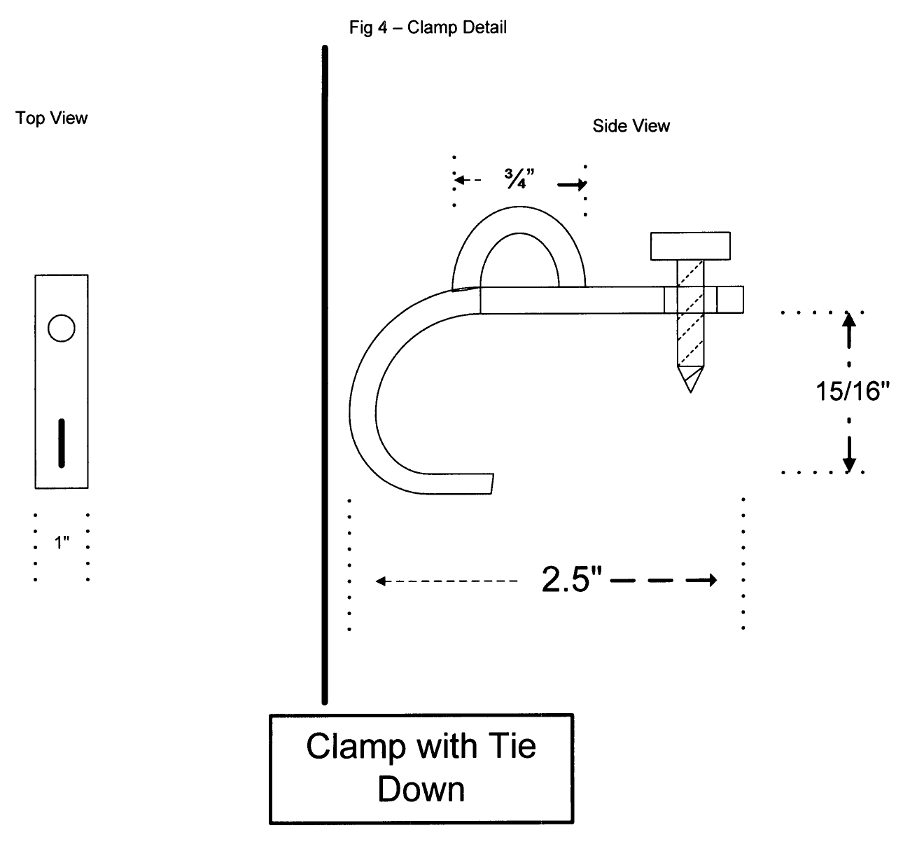

What is claimed

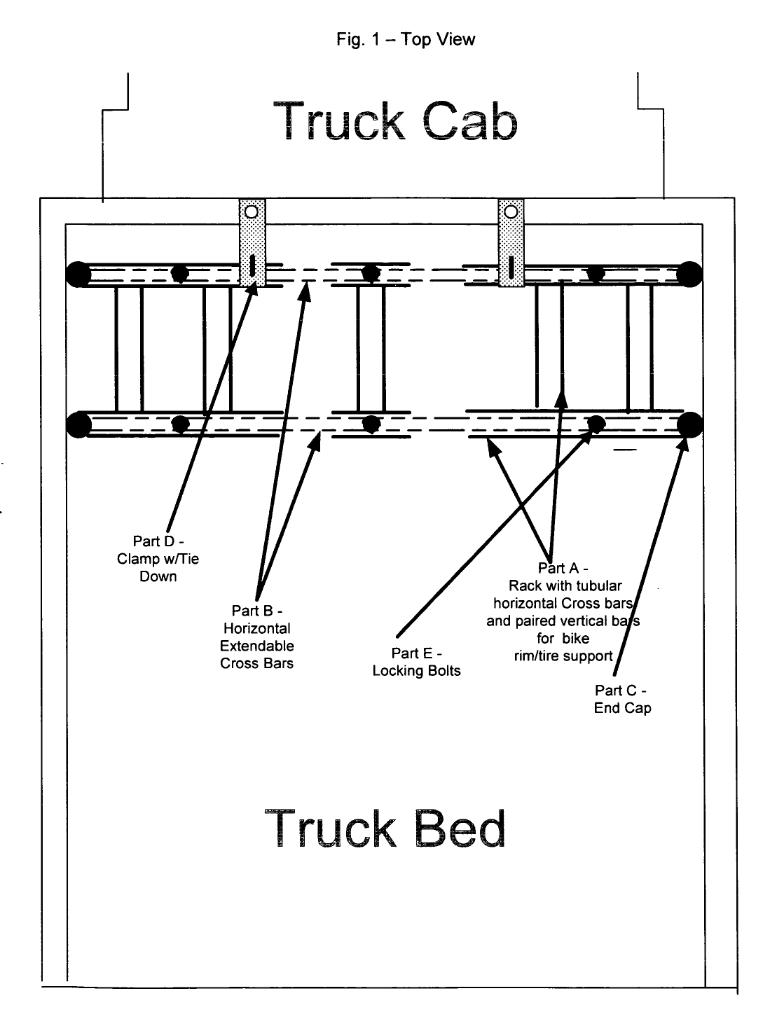

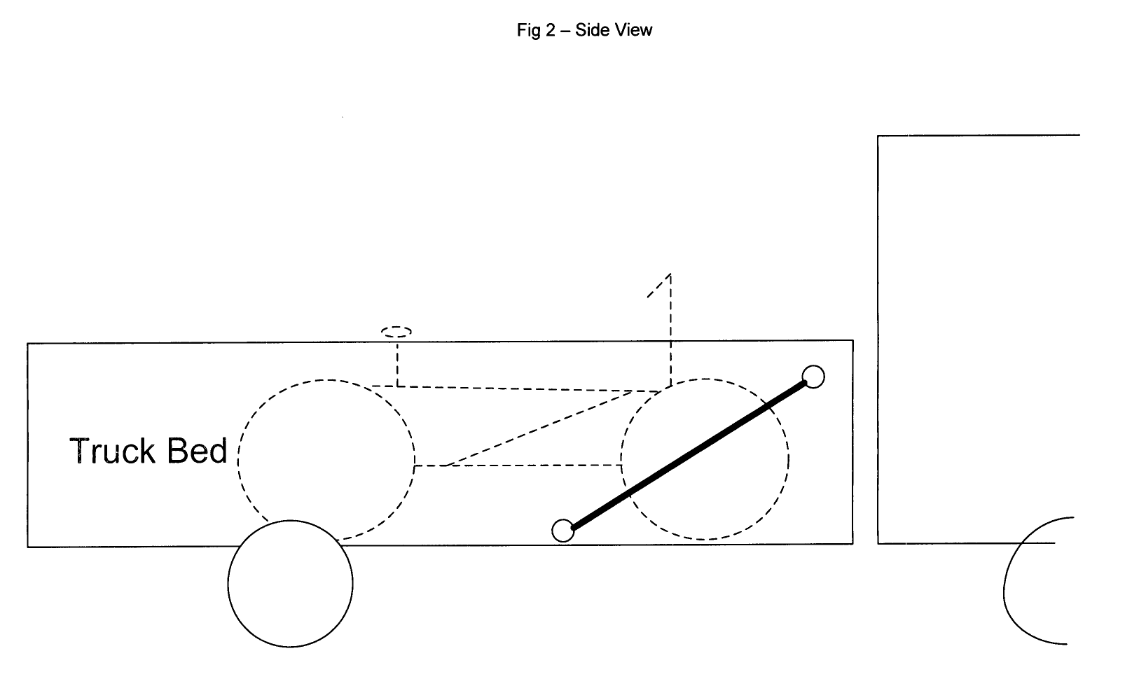

1. A bicycle rack that fits inside the back of a vehicle bed, consisting of (*FIGS. 1&3—Part A) Two (2) tubular horizontal cross bars, placed at the Top and Bottom (*FIG. 2 at a 25°-60° slope) of the vehicle bed with paired vertical bars to hold the tires of a bicycle in place.

2. A bicycle rack wherein the respective horizontal cross bars and vertical pairings are sectional and interconnectable, via (*FIGS. 1 & 3) extendable horizontal cross member bars.

3. A bicycle rack wherein the respective vertical paired connecting bars are spaced to fit the front or rear tire assembly of a bicycle in place and far enough apart to allow multiple bicycles to be stored.

4. An extendable tubular member (FIGS. 1 & 3—Part B)which fits inside respective bicycle rack cross rail support arm which when extended forms a pressure clamp between the side walls of the vehicle

5. (*FIGS. 1—Part C)End caps fitting over the extendable tubular members to prevent surface marring and provide additional support via friction.

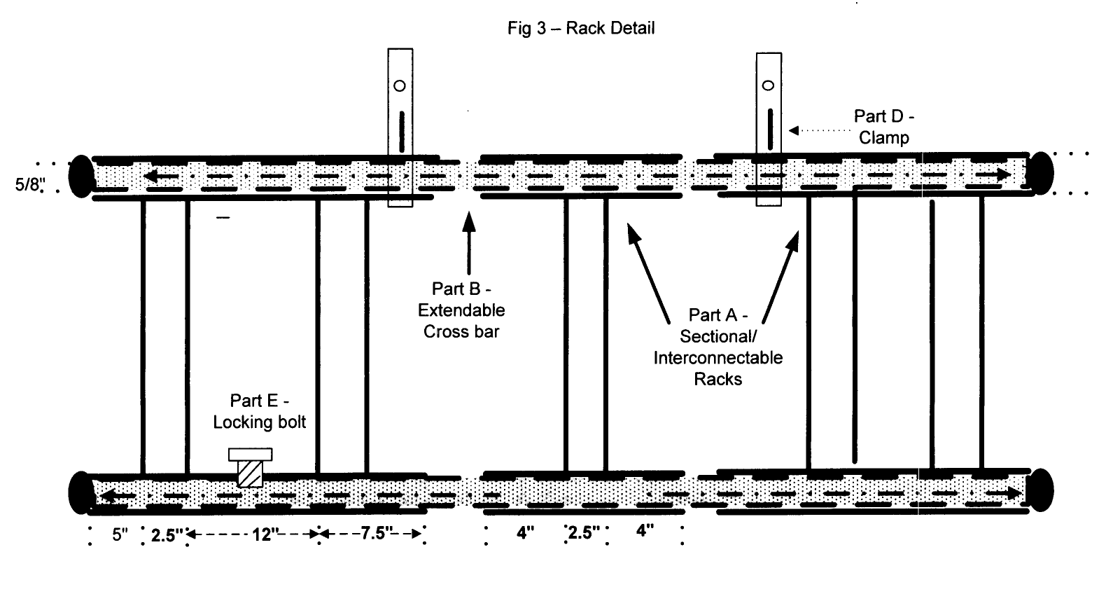

6. A (*FIGS. 1, 3 & 4—Part D) clamp which can be used to permanently mount above bicycle rack to the back wall of the truck bed.

7. A (*FIGS. 1 & 3—Part E) Locking Bolt to apply pressure (clamping) the extendable cross member in place.
